(19) United States
(12) Patent Application Publication
(10) Pub. No.: US 2020/0298885 A1
(43) Pub. Date: Sep. 24, 2020

(54) VEHICLE CONTROL APPARATUS, VEHICLE CONTROL METHOD, VEHICLE, AND STORAGE MEDIUM

(71) Applicant: HONDA MOTOR CO., LTD., Tokyo (JP)

(72) Inventor: Katsuya YASHIRO, Wako-shi (JP)

(21) Appl. No.: 16/801,640

(22) Filed: Feb. 26, 2020

(30) Foreign Application Priority Data
Mar. 19, 2019 (JP) 2019-051451

(51) Int. Cl. B60W 60/00; B60W 50/14; G05D 1/00; B60W 30/165

(52) U.S. Cl. CPC B60W 60/0055; B60W 50/14; G05D 1/0061; B60W 30/165; G05D 2201/0213; B60W 2554/804; B60W 2556/65; B60W 2554/4041; B60W 2530/201; B60W 2520/10

(57) ABSTRACT

A vehicle control apparatus comprises a periphery monitoring unit configured to be capable of detecting a front vehicle traveling in front of a vehicle, and a vehicle control unit configured to be capable of controlling the vehicle on the basis of a travel state of the vehicle or a travel state of the front vehicle. The vehicle control unit can carry out vehicle control in a first control state, as well as vehicle control in a second control state in which a level of autonomy of the vehicle control is higher or the extent to which a driver is required to contribute to vehicle operations is lower than in the first control state.

### CROSS-REFERENCE TO RELATED APPLICATION

This application claims priority to and the benefit of Japanese Patent Application No. 2019-051451 filed on Mar. 19, 2019, the entire disclosure of which is incorporated herein by reference.

### BACKGROUND OF THE INVENTION

### Field of the Invention

The present invention relates to a vehicle control apparatus, a vehicle control method, a vehicle, and a storage medium, and particularly relates to vehicle control techniques for autonomously-driven vehicles.

### Description of the Related Art

Japanese Patent No. 4193765 discloses a configuration in which an object in the surrounding area of a vehicle is detected by a plurality of sensors, and travel assistance control in the same control state is suppressed when the number of active detection devices decreases.

However, depending on the travel state of a self-vehicle, the travel state of a front vehicle traveling in front of the self-vehicle, and so on, there are cases where it is necessary to smoothly transition from the control state for the current vehicle control to a control state having a lower level of autonomy, or a control state where the driver contributes more to the vehicle operations.

The present invention provides a vehicle control technique that can smoothly transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

### SUMMARY OF THE INVENTION

According to one aspect of the present invention, there is provided a vehicle control apparatus that can control a vehicle on the basis of a plurality of control states, the apparatus comprising: a periphery monitoring unit configured to be capable of detecting a front vehicle traveling in front of the vehicle; and a vehicle control unit configured to be capable of controlling the vehicle on the basis of a travel state of the vehicle or a travel state of the front vehicle, wherein as vehicle control in the plurality of control states, the vehicle control unit can carry out vehicle control in a first control state, as well as vehicle control in a second control state in which a level of autonomy of the vehicle control is higher or the extent to which a driver is required to contribute to vehicle operations is lower than in the first control state; when, during vehicle control in the second control state, a threshold speed serving as an upper limit for carrying out vehicle control in the second control state has been reached or exceeded, the vehicle control unit carries out control to transition from vehicle control in the second control state to vehicle control in the first control state; and a first threshold speed and a second threshold speed are set as threshold speeds, the first threshold speed being for a speed of the vehicle, and the second threshold speed being for the speed of the front vehicle and being faster than the first threshold speed.

According to another aspect of the present invention, there is provided a vehicle control method of a vehicle control apparatus that can control a vehicle on the basis of a plurality of control states, the method comprising: an obtainment step of obtaining, from a periphery monitoring unit capable of detecting a front vehicle traveling in front of the vehicle, information of the front vehicle; and a vehicle control step of controlling the vehicle on the basis of a travel state of the vehicle or a travel state of the front vehicle, wherein in the vehicle control step: vehicle control in a first control state, as well as vehicle control in a second control state in which a level of autonomy of the vehicle control is higher or the extent to which a driver is required to contribute to vehicle operations is lower than in the first control state, can be carried out as vehicle control in the plurality of control states; when, during vehicle control in the second control state, a threshold speed serving as an upper limit for carrying out vehicle control in the second control state has been reached or exceeded, control to transition from vehicle control in the second control state to vehicle control in the first control state is carried out in the vehicle control step; and a first threshold speed and a second threshold speed are set as threshold speeds, the first threshold speed being for a speed of the vehicle, and the second threshold speed being for the speed of the front vehicle and being faster than the first threshold speed.

According to the present invention, it is possible to smoothly transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

### BRIEF DESCRIPTION OF THE DRAWINGS

FIG. 1A is a block diagram illustrating an example of the configuration of a vehicle control apparatus.

FIG. 1B is a diagram illustrating an example of the configuration of control blocks for controlling a vehicle.

FIG. 2 is a diagram illustrating the flow of processing in the vehicle control apparatus when a control state is transitioned from a first control state to a second control state.

FIG. 3 is a diagram illustrating the flow of processing in the vehicle control apparatus when the control state is transitioned from the second control state to the first control state.

FIG. 4 is a diagram illustrating the flow of processing in the vehicle control apparatus when the control state is transitioned from the second control state to the first control state.

FIG. 5 is a diagram schematically illustrating a travel state of a vehicle.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### Configuration of Vehicle Control Apparatus

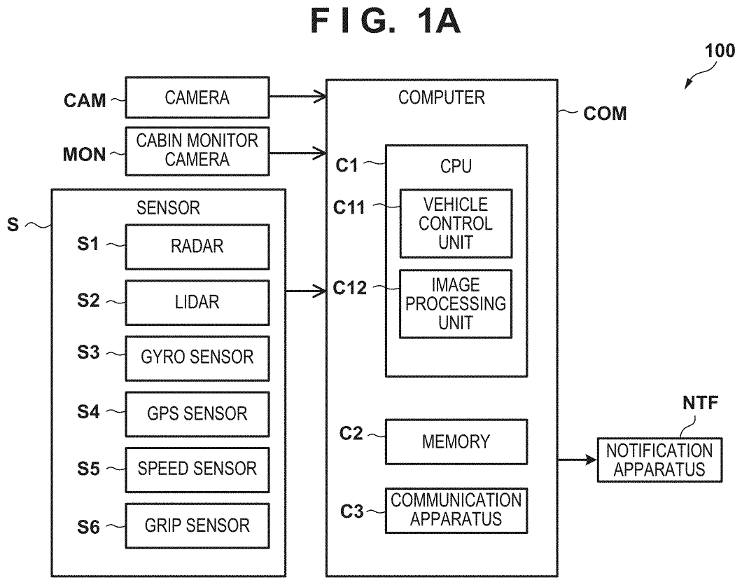

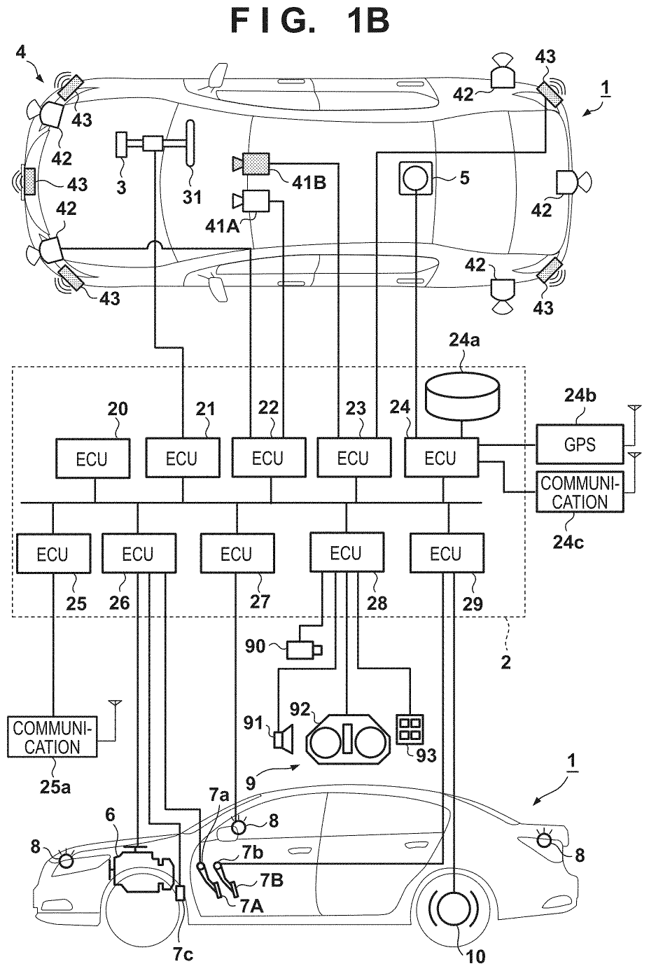

FIG. 1A is a diagram illustrating an example of the configuration of a travel control system including a vehicle control apparatus 100 that controls automated driving of a vehicle; the vehicle control apparatus 100 includes sensors S, a plurality of cameras CAM, a cabin monitor camera MON, and a computer COM. The sensors S include, for example, a plurality of radar S1, a plurality of LIDAR S2 (Light Detection and Ranging), a gyrosensor S3, a GPS sensor S4, a speed sensor S5, a grip sensor S6, and the like.

The computer COM includes a CPU (C1) that controls processing pertaining to controlling the automated driving of the vehicle, memory C2, a communication apparatus C3 that is connected to a network NET and that can communicate with a server apparatus located on the network, other vehicles located in the periphery of the vehicle (the self-vehicle), and so on. The sensors S and the cameras CAM obtain various types of information of the vehicle and input that information to the computer COM.

The CPU (C1) of the computer COM carries out image processing on image information input from the cameras CAM. On the basis of the camera image information subjected to the image processing and sensor information input from the sensors S (radar S1 and LIDAR S2), the CPU (C1) extracts an object present in the surrounding area of the self-vehicle, analyzes how the object is arranged in the surrounding area of the self-vehicle, and monitors the object.

The gyrosensor S3 detects rotational movement, the orientation, and so on of the self-vehicle, and the computer COM can determine the path of the self-vehicle on the basis of detection results from the gyrosensor S3, a speed detected by the speed sensor S5, and so on. The GPS sensor S4 detects the current position (position information) of the self-vehicle in map information.

The grip sensor S6 is built into a steering wheel of the vehicle, for example, and can detect whether or not a vehicle occupant (a driver) is gripping the steering wheel. The grip sensor S6 inputs detected steering wheel grip information to the computer COM. On the basis of the steering wheel grip information input from the grip sensor S6, the computer COM can determine whether or not a vehicle occupant (the driver) is gripping the steering wheel, i.e., whether the steering wheel is in a hands-on state or a hands-off state.

The cabin monitor camera MON is disposed so as to be capable of shooting an image of the interior of the vehicle, and shoots an image of a vehicle occupant. The cabin monitor camera MON inputs appearance information obtained by shooting an image of the vehicle occupant to the computer COM. By carrying out image processing on an image of the occupant of the vehicle input from the cabin monitor camera MON, the computer COM can detect the appearance information of the vehicle occupant, which includes the vehicle occupant's expression, facial orientation, line of sight, driving posture, how open/closed his/her eyes are, and so on. On the basis of the detected appearance information of the vehicle occupant, the computer COM can determine whether the state of the vehicle occupant (the driver) while driving is an eyes-on state or an eyes-off state.

A notification apparatus NTF includes an audio output apparatus and a display apparatus, and the audio output apparatus communicates information to the driver using audio. The display apparatus communicates information to the driver by displaying images.

The computer COM of the vehicle control apparatus 100 can control automated driving travel of the vehicle by causing the vehicle to transition among a plurality of control states on the basis of information of the peripheral environment of the vehicle. In other words, the computer COM obtains information of the peripheral environment of the vehicle using the information from the sensors S and the cameras CAM, and controls the automated driving travel of the vehicle by causing the vehicle control state to transition on the basis of the information of the peripheral environment.

The CPU (C1) of the computer COM functions as a vehicle control unit C11 and an image processing unit C12 by executing programs stored in the memory C2. The vehicle control unit C11 controls the vehicle on the basis of detection results from a detecting unit that detects information of the vehicle and information of the vehicle's periphery (the sensors S, the cameras CAM, and so on). The automated driving travel of the vehicle is controlled by one of the plurality of control states.

When the vehicle control apparatus 100 illustrated in FIG. 1A is installed in a vehicle, the computer COM may, for example, be provided in a recognition processing system ECU, an image processing system ECU, or the like that processes information from the sensors S, the cameras CAM, the cabin monitor camera MON, and the like, or may be provided in an ECU that controls the communication apparatus, an input/output device, and the like, or may be provided in an ECU in a control unit, an automated driving ECU, or the like that controls the driving of the vehicle. For example, as illustrated in FIG. 1B, which will be described below, functions may be distributed among a plurality of ECUs constituting the vehicle control apparatus 100, such as sensor S ECUs, camera ECUs, input/output device ECUs, and automated driving ECUs.

FIG. 1B is a diagram illustrating an example of the configuration of control blocks in the vehicle control apparatus 100 for controlling a vehicle 1. An overview of the vehicle 1 is illustrated in FIG. 1B, both as a plan view and as a side view. The vehicle 1 is, for example, a sedan-type four-wheeled passenger vehicle.

A control unit 2 in FIG. 1B controls the various units of the vehicle 1. The control unit 2 includes a plurality of ECUs 20 to 29, which are communicatively connected over an in-vehicle network. Each ECU (Electronic Control Unit) includes a processor such as a CPU (Central Processing Unit), a storage device such as semiconductor memory, an interface with external devices, and the like. The storage device stores programs executed by the processor, the data used in processing by the processor, and so on. Each ECU may include a plurality of processors, storage devices, interfaces, and so on.

Functions and the like handled by the ECUs 20 to 29 will be described hereinafter. Note that the number of ECUs, the functions handled by the ECUs, and so on can be designed as appropriate for the vehicle 1, and can be set at a finer or broader level than that described in the present embodiment.

The ECU 20 executes vehicle control pertaining to the automated driving of the vehicle 1 (the self-vehicle) according to the present embodiment. During automated driving, at least one of the steering and the acceleration/deceleration of the vehicle 1 is automatically controlled. Specific processing pertaining to the control involved in the automated driving will be described in detail later.

The ECU 20 controls the travel of the vehicle on the basis of the position of the vehicle 1 (the self-vehicle), the relative position of other vehicles present in the periphery of the vehicle 1, information of the road the vehicle 1 is traveling on, the map information, and so on, which indicate the surrounding conditions of the vehicle.

The ECU 21 controls an electric power steering device 3. The electric power steering device 3 includes a mechanism for turning the front wheels in response to a driver making a driving operation (turning operation) on a steering wheel 31. The electric power steering device 3 also includes a motor for assisting the turning operation or for producing drive power for automatically turning the front wheels, a sensor for detecting a steering angle, and the like. When the driving state of the vehicle 1 is automated driving, the travel direction of the vehicle 1 is controlled by the ECU 21 automatically controlling the electric power steering device 3 in accordance with instructions from the ECU 20.

The ECUs 22 and 23 control detecting units 41 to 43, which detect the surrounding conditions of the vehicle, and process information of detection results. The detecting unit 41 is an element corresponding to the cameras CAM of FIG. 1A, and is an image capturing device that detects an object in the surrounding area of the vehicle 1 by capturing an image (this may be referred to as cameras 41A and B hereinafter). The cameras 41 are attached to the windshield, within the vehicle cabin, in an area corresponding to a forward part of the roof of the vehicle 1, so as to be capable of shooting images of the area in front of the vehicle 1. By analyzing the images shot by the cameras 41A and B (image processing), the contours of objects such as a front vehicle traveling in front of the vehicle 1 in the lane in which the vehicle 1 is traveling, lane dividing lines (white lines and the like) on the road, and so on can be extracted, for example.

The detecting unit 42 (LIDAR detecting unit) is, for example, Light Detection and Ranging (LIDAR) (also called “LIDAR 42” hereinafter), which detects objects in the surrounding area of the vehicle 1, measures the distances to those objects, and so on by using light. The detecting unit 42 (LIDAR 42) is an element corresponding to LIDAR S2 in FIG. 1A. In the present embodiment, a plurality of LIDAR 42 are provided around the vehicle. In the example illustrated in FIG. 1B, five of the LIDAR 42 are provided, for example: one on each front corner of the vehicle 1, one in the rear center, and one each on the rear sides of the vehicle 1.

The detecting unit 43 (radar detecting unit) is, for example, millimeter wave radar (also called “radar 43” hereinafter), which detects objects in the surrounding area of the vehicle 1, measures the distances to those objects, and so on using millimeter waves. The detecting unit 43 (radar 43) is an element corresponding to the radar S1 in FIG. 1A. In the present embodiment, a plurality of radar 43 are provided around the vehicle. In the example illustrated in FIG. 1B, five of the radar 43 are provided, for example: one in the front center of the vehicle 1, one on each front corner, and one on each rear corner.

The ECU 22 controls the one camera 41A and each LIDAR 42, and processes information of the detection results therefrom. The ECU 23 controls the other camera 41B and each radar 43, and processes information of the detection results therefrom. By providing two sets of devices that detect the surrounding conditions of the vehicle, the reliability of the detection results can be improved; furthermore, by providing different types of detecting units, i.e., cameras, LiDAR, and radar, the peripheral environment of the vehicle can be analyzed in several different ways. Note that the ECU 22 and the ECU 23 may be realized by a single ECU.

The ECU 24 controls a gyrosensor 5, a GPS sensor 24b, and a communication apparatus 24c, and processes information of detection results or communication results therefrom. The gyrosensor 5 detects rotational movement of the vehicle 1. The path of the vehicle 1 can be determined from the detection results from the gyrosensor 5, the wheel speed, and so on. The GPS sensor 24b detects the current position of the vehicle 1. The communication apparatus 24c communicates wirelessly with a server apparatus that provides map information, traffic information, and the like, and obtains that information. The ECU 24 can access a map information database 24a provided in the storage device, and the ECU 24 searches for routes from the current location to a destination and the like. The database 24a can be located on a network, and the communication apparatus 24c can access the database 24a on the network and obtain the information. The gyrosensor 5, the GPS sensor 24b, and the communication apparatus 24c are elements corresponding to the gyrosensor S3, the GPS sensor S4, and the communication apparatus C3 of FIG. 1A, respectively.

The ECU 25 includes a communication apparatus 25a for vehicle-to-vehicle communication. The communication apparatus 25a communicates wirelessly with other vehicles in the periphery, and exchanges information with those vehicles.

The ECU 26 controls a power plant 6. The power plant 6 is a mechanism for outputting drive power that rotates drive wheels of the vehicle 1, and includes an engine and a transmission, for example. For example, the ECU 26 controls the output of the engine in response to a driving operation (an acceleration operation or a deceleration operation) made by the vehicle occupant (the driver), detected by an operation detecting sensor 7a provided in an accelerator pedal 7A, switches the gear ratio of the transmission on the basis of information such as a speed detected by a speed sensor 7c (the speed sensor S5 of FIG. 1A), and the like. When the driving state of the vehicle 1 is automated driving, the ECU 26 automatically controls the power plant 6 in response to instructions from the ECU 20, and controls the acceleration/deceleration of the vehicle 1.

The ECU 27 controls lights (headlights, taillights, and the like), including directional indicators 8. In the example illustrated in FIG. 1B, the directional indicators 8 are provided in a front area, a rear area, and on the door mirrors of the vehicle 1.

The ECU 28 can control an input/output device 9 and carry out image processing on a facial image of the driver input from a cabin monitoring camera 90. Here, the cabin monitoring camera 90 corresponds to the cabin monitor camera MON of FIG. 1A. The input/output device 9 outputs information to the vehicle occupant (the driver) and accepts settings from the driver. An audio output apparatus 91 communicates information to the driver through audio. A display apparatus 92 communicates information to the driver by displaying images. The display apparatus 92 is disposed, for example, in front of the driver's seat, and constitutes an instrument panel and the like, for example. Although audio and a display are mentioned here as examples, information may be communicated through vibrations, lights, or the like. The information may also be communicated using a combination of audio, a display, vibrations, and lights. Furthermore, the combinations may be varied, or the states of the notifications may be varied, in accordance with a level (e.g., a level of urgency) of the information to be communicated. The audio output apparatus 91 and the display apparatus 92 correspond to the notification apparatus NTF of FIG. 1A described earlier, for example.

An input apparatus 93 is disposed in a position where the device can be operated by the driver, and is a group of switches for making instructions to the vehicle 1; however, an audio input apparatus may be included as well.

The ECU 29 controls a braking apparatus 10, a parking brake (not shown), and the like. The braking apparatus 10 is, for example, a disk brake apparatus, provided in each of the wheels of the vehicle 1, which causes the vehicle 1 to decelerate or stop by applying resistance against the rotation of the wheels. The ECU 29 controls the operations of the braking apparatus 10 in response to a driving operation (a braking operation) made by the driver, detected by an operation detecting sensor 7b provided in a brake pedal 7B, for example. If the driving state of the vehicle 1 is automated driving, the ECU 29 controls the deceleration and stopping of the vehicle 1 by automatically controlling the braking apparatus 10 in response to instructions from the ECU 20. The braking apparatus 10, the parking brake, and the like can also be operated in order to keep the vehicle 1 in a stopped state. Furthermore, if the transmission of the power plant 6 is provided with a parking lock mechanism, that parking lock mechanism can also be operated in order to keep the vehicle 1 in a stopped state.

Plurality of Control States

In the present embodiment, vehicle control pertaining to steering, control, and the like, including vehicle acceleration and deceleration, lane changes, and so on, as well as tasks required of the vehicle occupant (the driver), are set in the plurality of control states. Tasks required of the vehicle occupant include operations required of the vehicle occupant in order to respond to the need to monitor the vehicle periphery, e.g., gripping the steering wheel (hands off or hands on), monitoring the periphery (eyes off or eyes on), handing off driving control, and so on.

The plurality of control states are classified into a plurality of stages in accordance with the extent of autonomy in the vehicle control (the level of autonomy), and the extent of the tasks required of the vehicle occupant (the driver) (the extent to which the vehicle occupant contributes to vehicle operations).

The vehicle control apparatus 100 can control the vehicle on the basis of the plurality of control states, and the vehicle control unit C11 can control the automated driving travel of the vehicle through one of the plurality of control states on the basis of periphery monitoring information (outside information) obtained from the LIDAR 42, the camera 41A, the radar 43, the camera 41B, and the like. For example, the sensors S and the cameras CAM (FIG. 1A), the detecting units 41 to 43 (the LIDAR 42, the camera 41A, the radar 43, and the camera 41B of FIG. 1B) function as a periphery monitoring unit capable of detecting a front vehicle traveling in front of the vehicle 1, and the vehicle control unit C11 can control the vehicle on the basis of the travel state of the vehicle 1 or the travel state of the front vehicle.

First Control State

In the present embodiment, the first control state is a control state in which a predetermined extent of autonomy in the vehicle control (the level of autonomy), and a predetermined extent of the tasks required of the vehicle occupant (the driver) (the extent to which the vehicle occupant contributes to vehicle operations), are set. In the first control state, the primary operator of the vehicle is the driver, and although the driver is required to monitor the periphery, the driver is not required to grip the steering wheel. The first control state is a control state that can be executed in, for example, a main lane of an uncongested highway.

Second Control State

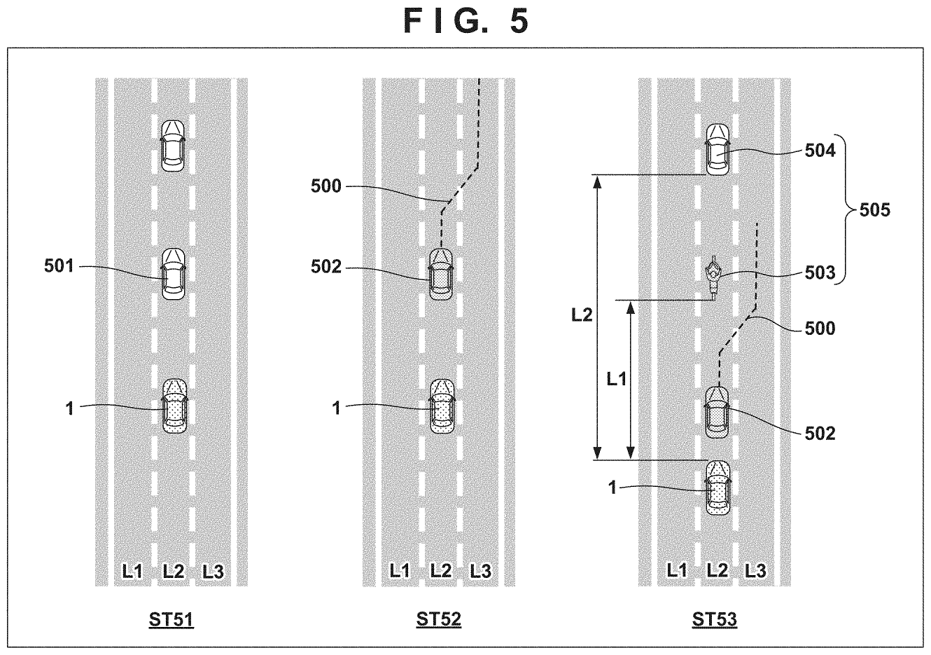

The second control state is a control state in which the level of autonomy (the extent of autonomy) of the vehicle control is higher, or the extent to which the driver is required to contribute to vehicle operations is lower, than in the first control state. In the second control state, the primary operator of the vehicle is the vehicle control apparatus 100 (a vehicle system), and the driver is required neither to monitor the periphery nor grip the steering wheel. However, the driver is required to monitor the vehicle system in preparation for an alert notification from the vehicle system. The second control state is a control state in which vehicle control can be carried out within the lane in which the vehicle 1 is traveling (e.g., L2, indicated in ST51 of FIG. 5), in a predetermined speed range in which vehicle control is active; for example, this control state can be executed in a travel situation where the vehicle 1 (the self-vehicle) follows a front vehicle 501 (ST1 in FIG. 5) in a main lane of a congested highway (Traffic Jam Pilot; TJP).

As control in the plurality of control states, the vehicle control unit C11 can carry out vehicle control in the first control state, as well as vehicle control in the second control state, in which the level of autonomy of the vehicle control is higher or the extent to which the driver is required to contribute to vehicle operations is lower than in the first control state.

Note that the control states are not limited to the foregoing examples, and for example, vehicle control can also be carried out in a control state in which the level of autonomy (the extent of autonomy) of the vehicle control is lower, or the extent to which the driver is required to contribute to vehicle operations is higher, than in the first control state (called a “third control state” hereinafter). In the third control state, the primary operator of the vehicle is the driver, and the driver is required to monitor the periphery. The driver is also required to grip the steering wheel.

Furthermore, in addition to the first to third control states, the vehicle control unit C11 can also control the vehicle in a mode in which no driving assistance is active.

Setting Threshold Vehicle Speed in Vehicle Control Apparatus Threshold Vehicle Speed Pertaining to Transition from Second Control State to First Control State

When, during vehicle control in the second control state, a threshold speed serving as an upper limit for carrying out vehicle control in the second control state has been reached or exceeded, the vehicle control unit C11 carries out control to transition from vehicle control in the second control state to vehicle control in the first control state. In the present embodiment, a plurality of threshold vehicle speeds serving as references are set in the vehicle control unit C11. In other words, a first threshold speed for the speed of the vehicle 1 (the self-vehicle), and a second threshold speed which is for the front vehicle and is faster than the first threshold speed, are set as threshold speeds.

For example, the first threshold speed (e.g., V1=40 km/h) is set for the speed of the vehicle 1 (the self-vehicle), and the second threshold speed, which is faster than the first threshold speed (e.g., V2=50 km/h) is set for the speed of the front vehicle (e.g., 501 in FIG. 5), as the threshold vehicle speeds used when starting a transition from the second control state to the first control state.

Assuming, for example, the same threshold speed is set for the vehicle 1 (the self-vehicle) and the front vehicle, if the front vehicle accelerates in a state where driving control is required to be handed off to the driver of the vehicle 1 (the self-vehicle) (e.g., a state of standing by to transition from the second control state to the first control state), the inter-vehicle distance will become greater than is necessary, and the transition to the new control state may therefore disrupt the flow of traffic.

In the present embodiment, the upper limit vehicle speed at which vehicle control is carried out in the second control state is set to the second threshold speed (V2) pertaining to the speed of the front vehicle. Additionally, the speed threshold for the vehicle 1 (the self-vehicle) is set lower than the second threshold speed so that the driver can respond to a driving handoff request output from the vehicle control apparatus 100 side and a smooth transition can be made from the second control state to the first control state. In other words, a slower vehicle speed than the vehicle speed serving as the upper limit at which vehicle control can be carried out in the second control state is set as the first threshold speed (V1) pertaining to the speed of the vehicle 1 (the self-vehicle).

When, during vehicle control in the second control state, a threshold speed serving as an upper limit for carrying out vehicle control in the second control state has been reached or exceeded, the vehicle control unit C11 carries out control to transition from vehicle control in the second control state to vehicle control in the first control state. In other words, when, during vehicle control in the second control state, the speed of the vehicle 1 (the self-vehicle) has become greater than or equal to the first threshold speed, or the speed of the front vehicle 501 has become greater than or equal to the second threshold speed, the vehicle control unit C11 transitions from vehicle control in the second control state to vehicle control in the first control state.

Note that the speeds indicated as the first threshold speed (V1) and the second threshold speed (V2) are merely examples, and it is sufficient for the relative relationship between the first threshold speed (V1) and the second threshold speed (V2) to be maintained. Additionally, during vehicle control in the second control state, it is also possible for the vehicle control unit C11 to transition from vehicle control in the second control state to vehicle control in the first control state under the conditions that the speed of the vehicle 1 (the self-vehicle) has become greater than or equal to the first threshold speed, and the speed of the front vehicle 501 has become greater than or equal to the second threshold speed.

Threshold Vehicle Speed Pertaining to Transition from First Control State to Second Control State

Additionally, a third threshold speed that is slower than the first threshold speed (e.g., V3=30 km/h) is set in the vehicle control unit C11 as a threshold vehicle speed used when starting a transition from the first control state to the second control state. When, during vehicle control in the first control state, the speed of the vehicle 1 (the self-vehicle) or the speed of the front vehicle 501 has become less than the third threshold speed, the vehicle control unit C11 transitions from vehicle control in the first control state to vehicle control in the second control state. When the speed of the vehicle 1 (the self-vehicle) becomes less than the third threshold speed and the vehicle control transitions from the first control state to the second control state, the control state remains the second control state until the speed of the vehicle 1 (the self-vehicle) becomes greater than or equal to the first threshold speed or the speed of the front vehicle 501 becomes greater than or equal to the second threshold speed.

Note that during vehicle control in the first control state, it is also possible for the vehicle control unit C11 to transition from vehicle control in the first control state to vehicle control in the second control state under the conditions that the speed of the vehicle 1 (the self-vehicle) and the speed of the front vehicle 501 have become less than the third threshold speed.

Process for Transitioning from First Control State to Second Control State

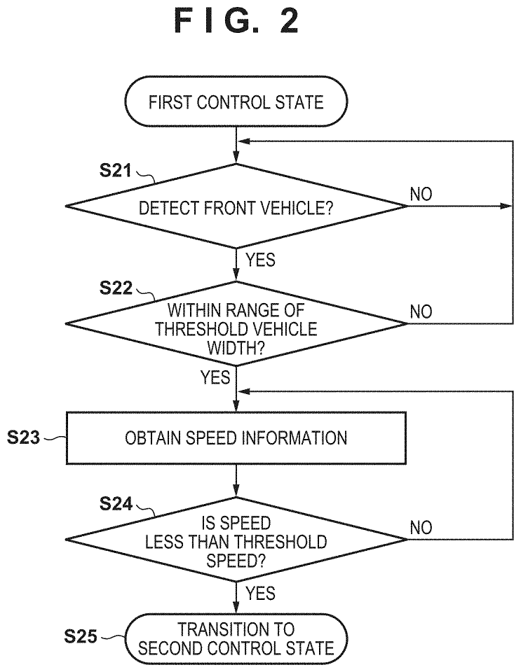

The flow of a process for transitioning from the first control state to the second control state in the vehicle control apparatus will be described next. FIG. 2 is a diagram illustrating the flow of processing carried out by the vehicle control apparatus 100 when the control state transitions from the first control state to the second control state, and the vehicle control apparatus 100 repeatedly executes the processing illustrated in FIG. 2 every predetermined sampling period while vehicle control is being carried out in the first control state.

In step S21, the vehicle control unit C11 determines whether or not there is a front vehicle traveling in front of the vehicle 1 on the basis of detection results from the periphery monitoring unit (the sensors S and the cameras CAM (FIG. 1A), the detecting units 41 to 43 (FIG. 1B), and so on).

Note that in the process of step S21, the vehicle control unit C11 can also obtain a degree to which a lane width overlaps with a vehicle width of the front vehicle as vehicle width direction position information of the front vehicle 501 in the lane. For example, if 10% of the vehicle width of the front vehicle is protruding into the adjacent lane, the vehicle control unit C11 obtains 90% as the degree to which the vehicle width of the front vehicle 501 overlaps in the lane, on the basis of the detection results from the periphery monitoring unit. Likewise, if 30% of the vehicle width of the front vehicle is protruding into the adjacent lane, the vehicle control unit C11 obtains 70% as the degree to which the vehicle width of the front vehicle 501 overlaps in the lane, on the basis of the detection results from the periphery monitoring unit.

The vehicle control unit C11 can determine changes in the vehicle width direction position information of the front vehicle 501 in the lane (changes in the position information occurring over time) on the basis of the detection results from the periphery monitoring unit. On the basis of changes in the vehicle width direction position information, the vehicle control unit C11 can determine whether or not the front vehicle 501 is gradually moving sideways toward the adjacent lane, to the right or to the left of the center of the lane.

The periphery monitoring unit can obtain dimension information indicating the extent to which the vehicle width of the front vehicle protrudes toward the adjacent lane as an amount of skew between the center of the lane width and the center of the vehicle width of the front vehicle, and can also obtain an amount of skew (offset amount) between the center of the lane width and the center of the vehicle width of the front vehicle, and determine whether or not the front vehicle 501 is in a state of gradually moving sideways from the center of the lane toward the adjacent lane on the basis of changes in the offset amount (changes in the offset amount over time).

Furthermore, in order to travel so as to follow the front vehicle, the vehicle control unit C11 can also determine the degree to which the vehicle width of the front vehicle overlaps with the vehicle width of the vehicle 1 (the self-vehicle) on the basis of the detection results from the periphery monitoring unit, and if there is skew with respect to the vehicle width direction, control the position with respect to the vehicle width direction so as to cancel out the skew.

When traffic jam pilot is carried out as the second control state, the presence of the front vehicle 501 (the front vehicle directly in front) traveling ahead of the vehicle 1 (the self-vehicle) in the same lane (e.g., L2 indicated in ST51 of FIG. 5) is a requirement for transitioning from the first control state to the second control state. For example, a situation where a front vehicle 502 has made a lane change 500 to an adjacent lane L3 and there is no longer any front vehicle in the lane L2 in which the vehicle 1 (the self-vehicle) is traveling, as indicated by ST52 in FIG. 5, does not meet the conditions for the transition.

Even if the front vehicle 501 is present within the lane width, the travel trajectory of the front vehicle 501 cannot be traced if the front vehicle 501 changes lanes by gradually moving sideways, to the right or to the left, from the center of the lane. To determine whether or not to change lanes, a threshold pertaining to sideways movement of the front vehicle 501 (a sideways movement reference value) may be set, and the vehicle control unit C11 may determine whether or not it is possible to follow the front vehicle 501 on the basis of the comparison between the sideways movement reference value and the position information of the front vehicle 501 in the lane.

Even if the front vehicle 501 is present within the lane width, the vehicle control unit C11 determines that the front vehicle will change lanes to an adjacent lane when the position information of the front vehicle 501 within the lane exceeds the sideways movement reference value. In such a case, the vehicle control unit C11 determines that the conditions for transitioning from the first control state to the second control state are not met.

In the determination of step S21, if a front vehicle has not been detected, or if a front vehicle has been detected but the position information of the front vehicle 501 in the lane exceeds the sideways movement reference value (step S21—No), the process of step S21 is repeatedly executed in a detection standby state. On the other hand, if a front vehicle has been detected in the determination process of step S21 (step S21—Yes), the vehicle control unit C11 moves the process to step S22.

In step S22, the vehicle control unit C11 determines whether the vehicle width of the detected front vehicle is within the range of a threshold vehicle width. In this step, the vehicle control unit C11 determines whether the front vehicle is a target for following travel, carried out in the vehicle control in the second control state, on the basis of a comparison between the vehicle width of the front vehicle and the threshold vehicle width serving as a reference. If the vehicle width of the front vehicle 501 exceeds an upper limit value of the threshold vehicle width serving as a reference, or is lower than a lower limit value of the threshold vehicle width, the vehicle control unit C11 determines that the front vehicle 501 is not a target for following travel carried out in the vehicle control in the second control state. In this case, the front vehicle 501 is assumed to be outside the range of the threshold vehicle width (step S22—No), and the vehicle control unit C11 therefore returns the process to step S21 and repeatedly executes the same process.

For example, when the vehicle 1 (the self-vehicle) is a sedan-type four-wheeled passenger vehicle, if a truck or the like that is larger than the vehicle 1 (the self-vehicle) becomes the front vehicle, it may be necessary to stay alert for cargo falling from the truck, for example. Meanwhile, if the front vehicle is a two-wheeled vehicle or the like, that vehicle has a narrower vehicle width than the vehicle 1 (the self-vehicle), and thus even if the front vehicle can travel through a given region, it may not be possible for the vehicle 1 (the self-vehicle) to travel through the same region. In this case, the range of the threshold vehicle width is set, and vehicles outside the range of the threshold vehicle width are excluded from targets for following travel carried out in the vehicle control in the second control state (the front vehicle).

On the other hand, if, in the determination process of step S22, the vehicle width of the front vehicle 501 is within the range of the threshold vehicle width (less than or equal to the upper limit value for the threshold vehicle width and greater than or equal to the lower limit value for the threshold vehicle width; S22—Yes), the vehicle control unit C11 sets the front vehicle 501 as a target for following travel, and moves the process to step S23.

In step S23, the vehicle control unit C11 obtains speed information of the vehicle 1 (the self-vehicle) and the front vehicle 501.

The vehicle control unit C11 can obtain the speed information of the vehicle 1 (the self-vehicle) and the speed information of the front vehicle detected by the periphery monitoring unit (the sensors S and the cameras CAM (FIG. 1A), the detecting units 41 to 43 (FIG. 1B), and so on). It is also possible for the vehicle control unit C11 to obtain the speed information of the front vehicle from a change over time in the relative distance to the vehicle (the self-vehicle) obtained in the detection results from the periphery monitoring unit. Alternatively, the vehicle control unit C11 can obtain the speed information through vehicle-to-vehicle communication with the front vehicle.

In step S24, the vehicle control unit C11 compares the speed information obtained in step S23 with a threshold speed (the third threshold speed). On the basis of the result of the comparison process, if, during vehicle control in the first control state, the speed of the vehicle 1 (the self-vehicle) or the speed of the front vehicle 501 has become less than the third threshold speed (step S24—Yes), the vehicle control unit C11 transitions from vehicle control in the first control state to vehicle control in the second control state (step S25).

On the other hand, if, in the comparison process carried out in step S24, the speed becomes greater than or equal to the threshold speed (the third threshold) (step S24—No), the process returns to step S23, where the speed information of the vehicle 1 (the self-vehicle) or the front vehicle 501 is obtained again and the comparison process of step S24 is carried out.

Note that conditions such as the type of the traveled road being a highway can also be included, as a prerequisite, as conditions for transitioning to a different control state.

Process for Transitioning from Second Control State to First Control State

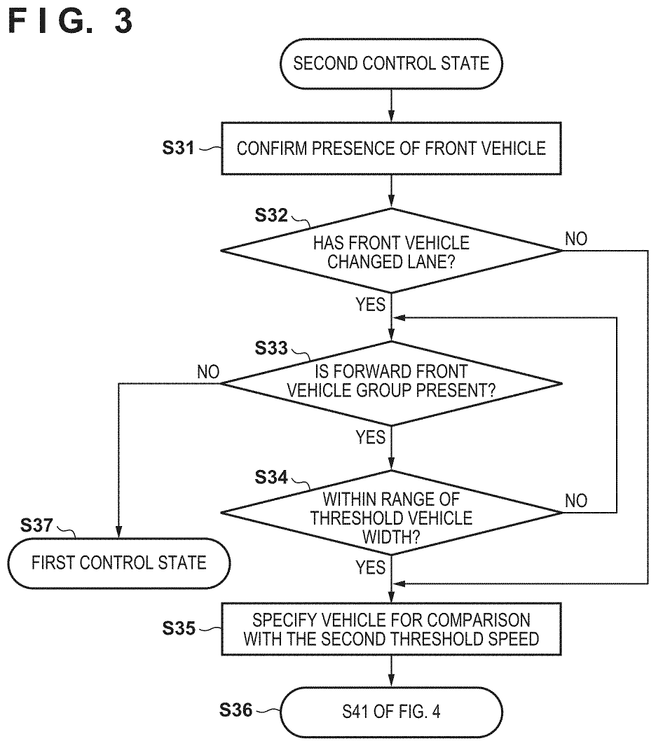

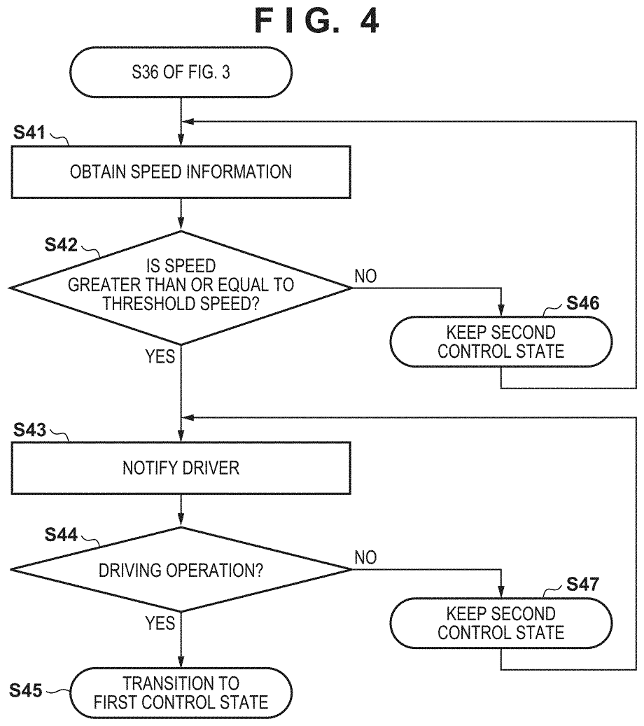

The flow of a process for transitioning from the second control state to the first control state in the vehicle control apparatus will be described next. FIGS. 3 and 4 are diagrams illustrating the flow of processing carried out by the vehicle control apparatus 100 when the control state transitions from the second control state to the first control state, and the vehicle control apparatus 100 repeatedly executes the processing illustrated in FIGS. 3 and 4 every predetermined sampling period while vehicle control is being carried out in the second control state.

In step S31, the vehicle control unit C11 confirms the presence of a front vehicle. The vehicle control unit C11 confirms the presence of the front vehicle 502 traveling in front of the vehicle 1 (the self-vehicle) in the same lane (e.g., L3 indicated in ST53 of FIG. 5) on the basis of the detection results from the periphery monitoring unit.

The communication apparatus 25a can communicate with other vehicles traveling in the periphery of the vehicle 1, and information can be exchanged with other vehicles in the periphery through wireless communication with those vehicles. On the basis of the information from at least one of the periphery monitoring unit and the communication apparatus 25a, the vehicle control unit C11 determines whether or not a forward front vehicle group 505, including at least one forward front vehicle (503 and 504) traveling in front of the front vehicle 502, is present in the same lane as the lane in which the vehicle 1 (the self-vehicle) is traveling and within a reference inter-vehicle distance from the vehicle 1 (ST53 in FIG. 5). Here, a vehicle traveling in front of the front vehicle 502 is called a “forward front vehicle”, and a plurality of vehicles including at least one forward front vehicle is called a “forward front vehicle group”.

Here, the vehicle control unit C11 compares inter-vehicle distances L1 and L2, respectively between the vehicle 1 and a first forward front vehicle 503 and a second forward front vehicle 504 included in the forward front vehicle group 505, with an inter-vehicle distance LS serving as a reference. If the inter-vehicle distances L1 and L2 are within the inter-vehicle distance LS serving as a reference, the vehicle control unit C11 sets the first forward front vehicle 503 and the second forward front vehicle 504 as candidates for targets of following travel. However, if the inter-vehicle distances L1 and L2 are greater than the inter-vehicle distance LS serving as a reference, the vehicle control unit C11 excludes the first forward front vehicle 503 and the second forward front vehicle 504 as candidates for targets of following travel. In this case, the vehicle control unit C11 determines that the forward front vehicle group 505 is not present in the same lane. In this step, the vehicle control unit C11 carries out the processes for confirming the presence of the front vehicle 502 and confirming the presence of the forward front vehicle group 505 in parallel.

In step S32, the vehicle control unit C11 determines whether the front vehicle 502 has changed lanes to the adjacent lane L3 and has therefore departed the lane L2 in which the vehicle 1 is traveling. If, in the determination of step S32, the front vehicle has not changed lanes (S32—No), the vehicle control unit C11 moves the process to step S35.

In step S32, the vehicle control unit C11 obtains the degree to which the lane width overlaps with the vehicle width of the front vehicle (or the amount of skew between the center of the lane width and the center of the vehicle width of the front vehicle) as position information of the front vehicle 501 in the lane, in the same manner as in the process of the earlier step S21. Then, the vehicle control unit C11 determines whether or not it is possible to follow the front vehicle 501 on the basis of a comparison between a threshold pertaining to sideways movement (the sideways movement reference value) and the position information of the front vehicle 501 in the lane. Even if the front vehicle 501 is present within the lane width, the vehicle control unit C11 determines that the front vehicle will change lanes to an adjacent lane when the position information of the front vehicle 501 within the lane exceeds the sideways movement reference value.

On the other hand, if, in the determination of step S32, the front vehicle 502 has changed lanes to the adjacent lane L3 (S32—Yes), the vehicle control unit C11 moves the process to step S33.

In step S33, the vehicle control unit C11 determines whether or not the forward front vehicle group 505 is present. If the forward front vehicle group 505 is not present in the same lane L2, i.e., if the front vehicle 502 has departed the same lane L2 by making a lane change (S32—Yes), and if the forward front vehicle group 505 traveling in front of the front vehicle 502 is not present (S33—No), the vehicle control unit C11 moves the process to step S37 and transitions from vehicle control in the second control state to vehicle control in the first control state.

On the other hand, if, in the determination process of step S33, the forward front vehicle group 505 is present (S33—Yes), the process moves to step S34.

In step S34, the vehicle control unit C11 determines whether the vehicle width of the forward front vehicle is within the range of a threshold vehicle width. The vehicle control unit C11 determines whether the front vehicle is to be a target for following travel, carried out in the vehicle control in the second control state, on the basis of a comparison between the vehicle width of the front vehicle or the vehicle width of a forward front vehicle included in the forward front vehicle group 505 and the threshold vehicle width serving as a reference.

For example, if the vehicle width of the first forward front vehicle 503 (a two-wheeled vehicle), which serves as the forward front vehicle included in the forward front vehicle group 505, exceeds an upper limit value of the threshold vehicle width serving as a reference, or is lower than a lower limit value of the threshold vehicle width, the vehicle control unit C11 excludes the first forward front vehicle from targets for following travel carried out in the vehicle control in the second control state. In other words, if the vehicle width of the first forward front vehicle 503 (a two-wheeled vehicle) is less than the lower limit value of the threshold vehicle width, the first forward front vehicle 503 is excluded from the targets for following travel.

In this case, the vehicle control unit C11 makes the same determination for the second forward front vehicle 504 (a sedan-type four-wheeled vehicle), which is a forward front vehicle included in the forward front vehicle group 505 and is a candidate for a target for the following travel. If the vehicle width of the second forward front vehicle 504, which is traveling in front of the first forward front vehicle 503 in the forward front vehicle group 505, is within the range of the threshold vehicle width, the vehicle control unit C11 sets the second forward front vehicle 504 as a target for following travel. If the vehicle width of the second forward front vehicle 504 is outside the range of the threshold vehicle width, the second forward front vehicle 504 is excluded from the targets for following travel.

The communication apparatus 25a can obtain dimension information including the vehicle width of the forward front vehicles included in the forward front vehicle group 505 through vehicle-to-vehicle communication, and the vehicle control unit C11 carries out the determination process on the basis of the information obtained by the communication apparatus 25a.

In step S35, the vehicle control unit C11 specifies a vehicle for comparison with the second threshold speed.

If, in the determination process of step S32, the front vehicle 502 is not changing lanes (S32—No), the vehicle control unit C11 specifies the front vehicle 502 as the vehicle for comparison with the second threshold speed.

On the other hand, if, in the determination process of step S32, the front vehicle 502 is changing lanes (S32—Yes), the forward front vehicle, among the forward front vehicle group 505, that is within the range of the threshold vehicle width is specified as the vehicle for comparison with the second threshold speed. For example, if the first forward front vehicle 503 has been excluded but the vehicle width of the second forward front vehicle 504 is within the range of the threshold vehicle width, the vehicle control unit C11 specifies the second forward front vehicle 504 as the vehicle for comparison with the second threshold speed.

In step S36, the vehicle control unit C11 moves the process to step S41 of FIG. 4.

In step S41 of FIG. 4, the vehicle control unit C11 obtains the speed information of the vehicle 1 (the self-vehicle) and the vehicle specified in step S35 of FIG. 3 (e.g., the front vehicle 502 or the second forward front vehicle 504).

The vehicle control unit C11 can obtain the speed information of the vehicle 1 (the self-vehicle) and the speed information of the specified vehicle (the front vehicle 502 or the second forward front vehicle 504), which are detected by the periphery monitoring unit.

It is also possible for the vehicle control unit C11 to obtain the speed information of the specified vehicle (the front vehicle 502 or the second forward front vehicle 504) from a change over time in the relative distance to the specified vehicle obtained in the detection results from the periphery monitoring unit. Alternatively, the vehicle control unit C11 can obtain the speed information through vehicle-to-vehicle communication with the specified vehicle.

In step S42, the vehicle control unit C11 compares the speed information obtained in step S41 with the threshold speeds (the first threshold speed and the second threshold speed).

When, during vehicle control in the second control state, the speed of the vehicle 1 (the self-vehicle) has become greater than or equal to the first threshold speed, or the speed of the front vehicle 502 (the forward front vehicle (504 in FIG. 5)) has become greater than or equal to the second threshold speed (S42—Yes), the vehicle control unit C11 moves the process to step S43 and transitions from vehicle control in the second control state to vehicle control in the first control state.

On the other hand, when, in the comparison process of step S42, the speed of the vehicle 1 (the self-vehicle) is less than the first threshold speed, or the speed of the front vehicle 502 (the forward front vehicle (504 in FIG. 5)) is less than the second threshold speed, the process returns to step S41 with the control state remaining the second control state, after which the same processing is repeated.

In step S43, the vehicle control unit C11 controls the notification apparatus NTF of FIG. 1A (or the audio output apparatus 91 and the display apparatus 92 of FIG. 1B) to notify the driver that he or she is to contribute to vehicle operations. In other words, when the speed of the vehicle 1 (the self-vehicle) has become greater than or equal to the first threshold speed, or the speed of the front vehicle 502 (the forward front vehicle (504 in FIG. 5)) has become greater than or equal to the second threshold speed, the vehicle control unit C11 controls the notification apparatus NTF to notify the driver that he or she is to contribute to vehicle operations (e.g., gripping the steering wheel), which had been reduced in the second control state.

In step S44, the vehicle control unit C11 determines whether or not the driver is operating the vehicle (e.g., gripping the steering wheel) using a contribution detecting unit (e.g., the grip sensor S6 of FIG. 1A). The vehicle control unit C11 carries out vehicle control in the second control state (step S47) until the contribution detecting unit (the grip sensor S6) detects that the driver is contributing to vehicle operations, and then returns the process to step S43, after which the same processing is repeated.

On the other hand, when, in the determination process of step S44, the contribution detecting unit (e.g., the grip sensor S6) has detected that the driver is contributing to vehicle operations (S44—Yes), the vehicle control unit C11 moves the process to step S45, and transitions from vehicle control in the second control state to vehicle control in the first control state.

### Second Embodiment

The first embodiment describes a configuration in which when a front vehicle has made a lane change to an adjacent lane and departed the lane L2 in which the vehicle 1 is traveling, the speed of the forward front vehicle present in the same lane is compared with the second threshold speed; however, it is also possible to compare that speed with a threshold speed that is slower than the second threshold speed. For example, it is also possible to set a fourth threshold speed (e.g., V4=45 km/h), which is faster than the first threshold speed but slower than the second threshold speed, as the threshold speed for transitioning from the second control state to the first control state, and carry out the comparison process of step S42 in FIG. 4 on the basis of a comparison between the fourth threshold speed and the speed of the forward front vehicle.

The forward front vehicle (e.g., the second forward front vehicle 504 in ST53 of FIG. 5) is a vehicle that has appeared as a result of the front vehicle 502 changing lanes, and thus using the slower threshold speed in the comparison process makes it possible to transition the control state more smoothly than with the conditions for the front vehicle 502.

### Third Embodiment

In the first embodiment, in step S35 of FIG. 3, the vehicle control unit C11 specifies a vehicle for comparison with the second threshold speed. For example, if, in the determination process of step S32 in FIG. 3, the front vehicle 502 is not changing lanes, the vehicle control unit C11 specifies the front vehicle 502 as the vehicle for comparison with the second threshold speed. Additionally, if the front vehicle 502 is changing lanes, the forward front vehicle, among the forward front vehicle group 505, that is within the range of the threshold vehicle width (e.g., the second forward front vehicle 504 in ST53 of FIG. 5) is specified as the vehicle for comparison with the second threshold speed.

However, when both speeds are contrary with respect to the second threshold speed, e.g., when the front vehicle 502 is changing lanes while accelerating at a speed greater than or equal to the second threshold speed or when the forward front vehicle (the second forward front vehicle 504) is traveling at less than the second threshold speed, preferentially comparing one of the speeds with the second threshold speed may result in a situation where the results of the comparison processes differ from each other.

Rather than being limited to specifying one of the vehicles as in the first embodiment, it is also possible to use the speed information of the front vehicle 502 and the second forward front vehicle 504 for the comparison with the second threshold speed, for example.

In other words, when, during vehicle control in the second control state, the front vehicle 502 has made a lane change to the adjacent lane and has departed from the lane in which the vehicle is traveling, the vehicle control unit C11 can also set the speed for comparing with the second threshold speed using the speed of the forward front vehicle (the second forward front vehicle 504) included in the forward front vehicle group 505 and the speed of the front vehicle 502 that has made the lane change.

The vehicle control unit C11 can also carry out the comparison process of step S42 in FIG. 4 having set the slower speed, obtained by comparing the speed of the forward front vehicle (the second forward front vehicle 504) with the speed of the front vehicle 502, as the speed for comparison with the second threshold speed.

In this case, when the speed of the vehicle is less than the first threshold speed and the speed obtained from the comparison (the slower speed) is less than the second threshold speed, the vehicle control unit C11 keeps the vehicle control in the second control state.

However, when the speed of the vehicle is greater than or equal to the first threshold speed or the speed obtained from the comparison (the slower speed) is greater than or equal to the second threshold speed, the vehicle control unit C11 transitions from vehicle control in the second control state to vehicle control in the first control state.

According to the present embodiment, even if both speeds are contrary with respect to the second threshold speed, e.g., when the front vehicle 502 is changing lanes while accelerating at a speed greater than or equal to the second threshold speed or when the forward front vehicle (the second forward front vehicle 504) is traveling at less than the second threshold speed, setting the speed for comparison with the second threshold speed using the speed of a forward front vehicle included in the forward front vehicle group and the speed of the front vehicle that has changed lanes makes it possible to apply the speed information of a plurality of vehicles traveling in front of the vehicle 1 in the determination for transitioning the control state.

### Fourth Embodiment

The third embodiment describes an example in which the slower speed, obtained by comparing the speed of the forward front vehicle (the second forward front vehicle 504) with the speed of the front vehicle 502, is set as the speed for comparison with the second threshold speed, but it is also possible to use an average speed.

The vehicle control unit C11 can also set a speed, obtained from the average of the speed of the forward front vehicle (the second forward front vehicle 504) and the speed of the front vehicle 502, as the speed for comparison with the second threshold speed.

In this case, when the speed of the vehicle is less than the first threshold speed and the speed obtained from the average is less than the second threshold speed, the vehicle control unit C11 keeps the vehicle control in the second control state.

However, when the speed of the vehicle is greater than or equal to the first threshold speed or the speed obtained from the average is greater than or equal to the second threshold speed, the vehicle control unit C11 transitions from vehicle control in the second control state to vehicle control in the first control state.

### Other Embodiments

A vehicle control program realizing one or more of the functions described in the embodiments can be supplied to a system or apparatus over a network or through a storage medium, and one or more processors in a computer of the system or apparatus can read out and execute the program. The present invention can be carried out in such a form as well.

### Summary of Embodiments

Configuration 1. A vehicle control apparatus according to the foregoing embodiments is a vehicle control apparatus that can control a vehicle on the basis of a plurality of control states (e.g., 100 in FIG. 1A), the apparatus including: a periphery monitoring unit (e.g., the sensors S and the cameras CAM (FIG. 1A), the detecting units 41 to 43 (the LIDAR 42, the camera 41A, the radar 43, and the camera 41B in FIG. 1B), and the like) configured to be capable of detecting a front vehicle traveling in front of the vehicle; and a vehicle control unit (e.g., C11 in FIG. 1A, the ECU 20 in FIG. 1B, and the like) configured to be capable of controlling the vehicle on the basis of a travel state of the vehicle or a travel state of the front vehicle, wherein the vehicle control unit (C11, the ECU 20, and the like) can carry out vehicle control in a first control state, as well as vehicle control in a second control state in which a level of autonomy of the vehicle control is higher or the extent to which a driver is required to contribute to vehicle operations is lower than in the first control state, as vehicle control in the plurality of control states; when, during vehicle control in the second control state, a threshold speed serving as an upper limit for carrying out vehicle control in the second control state has been reached or exceeded, the vehicle control unit carries out control to transition from vehicle control in the second control state to vehicle control in the first control state; and a first threshold speed and a second threshold speed are set as threshold speeds, the first threshold speed being for a speed of the vehicle, and the second threshold speed being for the speed of the front vehicle and being faster than the first threshold speed.

According to the vehicle control apparatus of Configuration 1, it is possible to smoothly transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

Configuration 2. In the vehicle control apparatus (100) according to the foregoing embodiments, when the speed of the vehicle has become greater than or equal to the first threshold speed, or the speed of the front vehicle has become greater than or equal to the second threshold speed, the vehicle control unit (C11, the ECU 20, and the like) carries out control so as to transition from vehicle control in the second control state to vehicle control in the first control state.

According to the vehicle control apparatus of Configuration 2, it is possible to smoothly transition from the control state for current vehicle control to a control state having a lower level of autonomy, or a control state where a driver contributes more to vehicle operations, when the speed of the vehicle serving as the travel state of the vehicle has become greater than or equal to the first threshold speed, or when the speed of the front vehicle serving as the travel state of the front vehicle traveling in front of the vehicle has become greater than or equal to the second threshold speed.

Configuration 3. The vehicle control apparatus (100) according to the foregoing embodiments, further including: a notification unit (e.g., the notification apparatus NTF in FIG. 1A, the audio output apparatus 91 and the display apparatus 92 in FIG. 1B) configured to notify the driver that they are to contribute to vehicle operations reduced under the second control state, when the speed of the vehicle has become greater than or equal to the first threshold speed or when the speed of the front vehicle has become greater than or equal to the second threshold speed; and a contribution detecting unit (e.g., the grip sensor S6 in FIG. 1A) configured to detect the contribution to the vehicle operations, wherein the vehicle control unit (C11, the ECU 20, and the like) carries out vehicle control in the second control state until the contribution detecting unit (the grip sensor S6) detects that the driver is contributing to the vehicle operations.

Configuration 4. In the vehicle control apparatus (100) according to the foregoing embodiments, when the contribution detecting unit (the grip sensor S6) detects that the driver is contributing to the vehicle operations, the vehicle control unit (C11, the ECU 20, and the like) transitions from vehicle control in the second control state to vehicle control in the first control state.

According to the vehicle control apparatus of Configurations 3 and 4, the second control state, in which vehicle control is carried out at a low speed, can be maintained until it is detected that the driver is contributing to the vehicle operations, and the vehicle control can be carried out in a range defined by the second control state until the contribution to vehicle operations is detected with certainty.

Configuration 5. In the vehicle control apparatus (100) according to the foregoing embodiments, a third threshold speed is set as a threshold speed for transitioning from the first control state to the second control state, the third threshold speed being slower than the first threshold speed; and when, during vehicle control in the first control state, the speed of the vehicle or the speed of the front vehicle has become less than the third threshold speed, the vehicle control unit (C11, the ECU 20, and the like) transitions from vehicle control in the first control state to vehicle control in the second control state.

According to the vehicle control apparatus of Configuration 5, by setting the third threshold speed, which is slower than the first threshold speed, as the threshold speed for transitioning from the first control state to the second control state, interference among the plurality of control states can be avoided, and the control state transitions can be carried out smoothly.

Configuration 6. The vehicle control apparatus (100) according to the foregoing embodiments, further including a communication unit (e.g., C3 in FIG. 1A, the communication apparatus 25a in FIG. 1B) configured to be capable of communicating with another vehicle traveling in the periphery of the vehicle, wherein on the basis of information from at least one of the periphery monitoring unit and the communication unit, the vehicle control unit (C11, the ECU 20, and the like) determines whether or not a forward front vehicle group (e.g., 505 in FIG. 5) including at least one forward front vehicle (e.g., 503 and 504 in FIG. 5) traveling in front of the front vehicle is present in the same lane as a lane in which the vehicle is traveling and within a reference inter-vehicle distance from the vehicle.

According to the vehicle control apparatus of Configuration 6, by suppressing the frequency with which control state transitions can occur each time the front vehicle changes lanes and determining whether or not the forward front vehicle is present in parallel, the following travel can be continued in the second control state on the basis of information of the forward front vehicle, even if the front vehicle has made a lane change and departed the lane of travel.

Configuration 7. In the vehicle control apparatus (100) according to the foregoing embodiments, when, during vehicle control in the second control state, the front vehicle has made a lane change to an adjacent lane and has departed from the lane in which the vehicle is traveling, the vehicle control unit (C11, the ECU 20, and the like) sets a speed for comparing with the second threshold speed using a speed of a forward front vehicle included in the forward front vehicle group and the speed of the front vehicle that has made the lane change.

According to the vehicle control apparatus of Configuration 7, setting the speed for comparison with the second threshold speed using the speed of a forward front vehicle included in the forward front vehicle group and the speed of the front vehicle that has changed lanes makes it possible to apply the speed information of a plurality of vehicles traveling in front of the vehicle in the determination for transitioning the control state, which makes it possible to transition the control states more smoothly.

Configuration 8. In the vehicle control apparatus (100) according to the foregoing embodiments, the vehicle control unit (C11, the ECU 20, and the like) compares the speed of the forward front vehicle with the speed of the front vehicle and sets the slower of the speeds as the speed for comparison with the second threshold speed.

Configuration 9. In the vehicle control apparatus (100) according to the foregoing embodiments, when the speed of the vehicle is less than the first threshold speed and the speed obtained from the comparison is less than the second threshold speed, the vehicle control unit (C11, the ECU 20, and the like) keeps the vehicle control in the second control state.

Configuration 10. In the vehicle control apparatus (100) according to the foregoing embodiments, when the speed of the vehicle is greater than or equal to the first threshold speed, or the speed obtained from the comparison is greater than or equal to the second threshold speed, the vehicle control unit (C11, the ECU 20, and the like) transitions from vehicle control in the second control state to vehicle control in the first control state.

According to the vehicle control apparatus of Configurations 8 to 10, setting the speed for comparison with the second threshold speed to the slower speed obtained by comparing the speed of a forward front vehicle included in the forward front vehicle group with the speed of the front vehicle that has changed lanes makes it possible to apply the speed information of a plurality of vehicles traveling in front of the vehicle in the determination for transitioning the control state, which makes it possible to transition the control states more smoothly.

Configuration 11. In the vehicle control apparatus (100) according to the foregoing embodiments, the vehicle control unit (C11, the ECU 20, and the like) sets a speed obtained from the average of the speed of the forward front vehicle and the speed of the front vehicle as the speed for comparison with the second threshold speed.

Configuration 12. In the vehicle control apparatus (100) according to the foregoing embodiments, when the speed of the vehicle is less than the first threshold speed and the speed obtained from the average is less than the second threshold speed, the vehicle control unit (C11, the ECU 20, and the like) keeps the vehicle control in the second control state.

Configuration 13. In the vehicle control apparatus (100) according to the foregoing embodiments, when the speed of the vehicle is greater than or equal to the first threshold speed, or the speed obtained from the average is greater than or equal to the second threshold speed, the vehicle control unit (C11, the ECU 20, and the like) transitions from vehicle control in the second control state to vehicle control in the first control state.

According to the vehicle control apparatuses of Configurations 11 to 13, setting the speed for comparison with the second threshold speed to the speed obtained from the average of the speed of a forward front vehicle included in the forward front vehicle group with the speed of the front vehicle that has changed lanes makes it possible to apply the speed information of a plurality of vehicles traveling in front of the vehicle in the determination for transitioning the control state, which makes it possible to transition the control states more smoothly.

Configuration 14. In the vehicle control apparatus (100) according to the foregoing embodiments, when, during the vehicle control in the second control state, the front vehicle (e.g., 502 in ST53 of FIG. 5) has made a lane change to an adjacent lane and has departed the lane in which the vehicle is traveling, if the forward front vehicle group (e.g., 505 in ST53 of FIG. 5) is not present in the lane, the vehicle control unit (C11, the ECU 20, and the like) transitions from vehicle control in the second control state to vehicle control in the first control state.

According to the vehicle control apparatus of Configuration 14, no vehicle traveling in front in the lane in which the self-vehicle is traveling means that there is not target for the following travel in the second control state, and thus the control state can transition from the second control state to the first control state regardless of the conditions for the speed of the self-vehicle.

Configuration 15. In the vehicle control apparatus (100) according to the foregoing embodiments, the vehicle control unit (C11, the ECU 20, and the like) determines whether the front vehicle (e.g., 501 in ST51, and 502 in ST52 and ST53, of FIG. 5) is to be used for following travel, carried out in the vehicle control in the second control state, on the basis of a comparison between a vehicle width of the front vehicle or a vehicle width of a forward front vehicle (e.g., 503 and 504 in ST53 of FIG. 5) included in the forward front vehicle group and a threshold vehicle width serving as a reference.

Configuration 16. In the vehicle control apparatus (100) according to the foregoing embodiments, when a vehicle width of a first forward front vehicle (e.g., 503 in ST53 of FIG. 5) serving as the forward front vehicle included in the forward front vehicle group (505) exceeds an upper limit value of the threshold vehicle width serving as a reference, or is lower than a lower limit value of the threshold vehicle width, the vehicle control unit (C11, the ECU 20, and the like) excludes the first forward front vehicle as a target for following travel carried out in the vehicle control in the second control state.

Configuration 17. In the vehicle control apparatus (100) according to the foregoing embodiments, when a vehicle width of a second forward front vehicle (e.g., 504 in ST53 of FIG. 5) traveling in front of the first forward front vehicle (503) in the forward front vehicle group (505) is within a range of the threshold vehicle width, the vehicle control unit (C11, the ECU 20, and the like) sets the second forward front vehicle (504) as a target for following travel.

According to the vehicle control apparatuses of Configurations 15 to 17, a range is set for the threshold vehicle width, and vehicles outside the range of the threshold vehicle width can be excluded from the targets (front vehicles) for the following travel carried out in the vehicle control in the second control state, whereas vehicles within the range of the threshold vehicle width can be set as targets for the following travel carried out in the vehicle control in the second control state.

When the vehicle (the self-vehicle) is a sedan-type four-wheeled passenger vehicle, for example, if a truck or the like that is larger than the self-vehicle becomes the front vehicle, it may be necessary to stay alert for cargo falling from the truck, for example. Meanwhile, if the front vehicle is a two-wheeled vehicle or the like, that vehicle has a narrower vehicle width than the self-vehicle, and thus even if the front vehicle (a two-wheeled vehicle or the like) can travel through a given region, it may not be possible for the self-vehicle to travel through the same region. Accordingly, a range is set for the threshold vehicle width, and vehicles outside the range of the threshold vehicle width can be excluded from the targets (front vehicles) for the following travel carried out in the vehicle control in the second control state, whereas vehicles within the range of the threshold vehicle width can be set as targets for the following travel carried out in the vehicle control in the second control state; this makes it possible to transition the control states more smoothly.

Configuration 18. A vehicle according to the foregoing embodiments (e.g., the vehicle 1 in FIG. 1B) is a vehicle capable of traveling on the basis of control by a vehicle control apparatus, and includes the vehicle control apparatus according to any one of Configurations 1 to 17 (e.g., the vehicle control apparatus 100 in FIG. 1A).

According to the vehicle of Configuration 18, it is possible to provide a vehicle control technique that can smoothly transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

Configuration 19. A vehicle control method of the vehicle control apparatus (100) according to the foregoing embodiments is a vehicle control method of a vehicle control apparatus that can control a vehicle on the basis of a plurality of control states, the method including: an obtainment step of obtaining, from a periphery monitoring unit capable of detecting a front vehicle traveling in front of the vehicle, information of the front vehicle; and a vehicle control step of controlling the vehicle on the basis of a travel state of the vehicle or a travel state of the front vehicle, wherein in the vehicle control step, vehicle control in a first control state, as well as vehicle control in a second control state in which a level of autonomy of the vehicle control is higher or the extent to which a driver is required to contribute to vehicle operations is lower than in the first control state, can be carried out as vehicle control in the plurality of control states; when, during vehicle control in the second control state, a threshold speed serving as an upper limit for carrying out vehicle control in the second control state has been reached or exceeded, control to transition from vehicle control in the second control state to vehicle control in the first control state is carried out in the vehicle control step; and a first threshold speed and a second threshold speed are set as threshold speeds, the first threshold speed being for a speed of the vehicle, and the second threshold speed being for the speed of the front vehicle and being faster than the first threshold speed.

According to the vehicle control method of a vehicle control apparatus of Configuration 19, it is possible to smoothly transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

Configuration 20. A program according to the foregoing embodiments causes a computer (e.g., the CPU in FIG. 1A) to execute the steps of the vehicle control method according to Configuration 19.

According to the program of Configuration 20, it is possible to provide a program that can smoothly control a transition from the control state for current vehicle control to a control state having a lower level of autonomy, or a control state where a driver contributes more to vehicle operations, in accordance with changes in a travel state of the vehicle, a travel state of a front vehicle traveling in front of the vehicle, and so on.

The invention is not limited to the foregoing embodiments, and various variations/changes are possible within the spirit of the invention.

What is claimed is:

1. A vehicle control apparatus that can control a vehicle on the basis of a plurality of control states, the apparatus comprising:
a periphery monitoring unit configured to be capable of detecting a front vehicle traveling in front of the vehicle; and
a vehicle control unit configured to be capable of controlling the vehicle on the basis of a travel state of the vehicle or a travel state of the front vehicle,
wherein as vehicle control in the plurality of control states, the vehicle control unit can carry out vehicle control in a first control state, as well as vehicle control in a second control state in which a level of autonomy of the vehicle control is higher or the extent to which a driver is required to contribute to vehicle operations is lower than in the first control state;
when, during vehicle control in the second control state, a threshold speed serving as an upper limit for carrying out vehicle control in the second control state has been reached or exceeded, the vehicle control unit carries out control to transition from vehicle control in the second control state to vehicle control in the first control state; and
a first threshold speed and a second threshold speed are set as threshold speeds, the first threshold speed being for a speed of the vehicle, and the second threshold speed being for the speed of the front vehicle and being faster than the first threshold speed.

2. The vehicle control apparatus according to claim 1,
wherein when the speed of the vehicle has become greater than or equal to the first threshold speed, or the speed of the front vehicle has become greater than or equal to the second threshold speed, the vehicle control unit carries out control so as to transition from vehicle control in the second control state to vehicle control in the first control state.

3. The vehicle control apparatus according to claim 1, further comprising:
a notification unit configured to notify the driver that they are to contribute to vehicle operations reduced under the second control state, when the speed of the vehicle has become greater than or equal to the first threshold speed or when the speed of the front vehicle has become greater than or equal to the second threshold speed; and
a contribution detecting unit configured to detect the contribution to the vehicle operations,
wherein the vehicle control unit carries out vehicle control in the second control state until the contribution detecting unit detects that the driver is contributing to the vehicle operations.

4. The vehicle control apparatus according to claim 3,
wherein when the contribution detecting unit detects that the driver is contributing to the vehicle operations, the vehicle control unit transitions from vehicle control in the second control state to vehicle control in the first control state.

5. The vehicle control apparatus according to claim 1,
wherein a third threshold speed is set as a threshold speed for transitioning from the first control state to the second control state, the third threshold speed being slower than the first threshold speed; and
when, during vehicle control in the first control state, the speed of the vehicle or the speed of the front vehicle has become less than the third threshold speed, the vehicle control unit transitions from vehicle control in the first control state to vehicle control in the second control state.

6. The vehicle control apparatus according to claim 1, further comprising:
a communication unit configured to be capable of communicating with another vehicle traveling in the periphery of the vehicle,
wherein on the basis of information from at least one of the periphery monitoring unit and the communication unit, the vehicle control unit determines whether or not a forward front vehicle group including at least one forward front vehicle traveling in front of the front vehicle is present in the same lane as a lane in which the vehicle is traveling and within a reference inter-vehicle distance from the vehicle.

7. The vehicle control apparatus according to claim 6,
wherein when, during vehicle control in the second control state, the front vehicle has made a lane change to an adjacent lane and has departed from the lane in which the vehicle is traveling, the vehicle control unit sets a speed for comparing with the second threshold speed using a speed of a forward front vehicle included in the forward front vehicle group and the speed of the front vehicle that has made the lane change.

8. The vehicle control apparatus according to claim 7,
wherein the vehicle control unit compares the speed of the forward front vehicle with the speed of the front vehicle and sets the slower of the speeds as the speed for comparison with the second threshold speed.

9. The vehicle control apparatus according to claim 8,
wherein when the speed of the vehicle is less than the first threshold speed and the speed obtained from the comparison is less than the second threshold speed, the vehicle control unit keeps the vehicle control in the second control state.

10. The vehicle control apparatus according to claim 8,
wherein when the speed of the vehicle is greater than or equal to the first threshold speed, or the speed obtained from the comparison is greater than or equal to the second threshold speed, the vehicle control unit transitions from vehicle control in the second control state to vehicle control in the first control state.

11. The vehicle control apparatus according to claim 7,
wherein the vehicle control unit sets a speed obtained from the average of the speed of the forward front vehicle and the speed of the front vehicle as the speed for comparison with the second threshold speed.

12. The vehicle control apparatus according to claim 11,
wherein when the speed of the vehicle is less than the first threshold speed and the speed obtained from the average is less than the second threshold speed, the vehicle control unit keeps the vehicle control in the second control state.

13. The vehicle control apparatus according to claim 11,
wherein when the speed of the vehicle is greater than or equal to the first threshold speed, or the speed obtained from the average is greater than or equal to the second threshold speed, the vehicle control unit transitions from vehicle control in the second control state to vehicle control in the first control state.

14. The vehicle control apparatus according to claim 6,
wherein when, during the vehicle control in the second control state, the front vehicle has made a lane change to an adjacent lane and has departed the lane in which the vehicle is traveling, if the forward front vehicle group is not present in the lane, the vehicle control unit transitions from vehicle control in the second control state to vehicle control in the first control state.

15. The vehicle control apparatus according to claim 6,
wherein the vehicle control unit determines whether the front vehicle is to be used for following travel, carried out in the vehicle control in the second control state, on the basis of a comparison between a vehicle width of the front vehicle or a vehicle width of a forward front vehicle included in the forward front vehicle group and a threshold vehicle width serving as a reference.

16. The vehicle control apparatus according to claim 15,
wherein when a vehicle width of a first forward front vehicle serving as the forward front vehicle included in the forward front vehicle group exceeds an upper limit value of the threshold vehicle width serving as a reference, or is lower than a lower limit value of the threshold vehicle width, the vehicle control unit excludes the first forward front vehicle as a target for following travel carried out in the vehicle control in the second control state.

17. The vehicle control apparatus according to claim 16,
wherein when a vehicle width of a second forward front vehicle traveling in front of the first forward front vehicle in the forward front vehicle group is within a range of the threshold vehicle width, the vehicle control unit sets the second forward front vehicle as a target for following travel.

18. A vehicle capable of traveling on the basis of control by a vehicle control apparatus, the vehicle comprising:
the vehicle control apparatus according to claim 1.

19. A vehicle control method of a vehicle control apparatus that can control a vehicle on the basis of a plurality of control states, the method comprising:
an obtainment step of obtaining, from a periphery monitoring unit capable of detecting a front vehicle traveling in front of the vehicle, information of the front vehicle; and
a vehicle control step of controlling the vehicle on the basis of a travel state of the vehicle or a travel state of the front vehicle,
wherein in the vehicle control step:
vehicle control in a first control state, as well as vehicle control in a second control state in which a level of autonomy of the vehicle control is higher or the extent to which a driver is required to contribute to vehicle operations is lower than in the first control state, can be carried out as vehicle control in the plurality of control states;
when, during vehicle control in the second control state, a threshold speed serving as an upper limit for carrying out vehicle control in the second control state has been reached or exceeded, control to transition from vehicle control in the second control state to vehicle control in the first control state is carried out in the vehicle control step; and
a first threshold speed and a second threshold speed are set as threshold speeds, the first threshold speed being for a speed of the vehicle, and the second threshold speed being for the speed of the front vehicle and being faster than the first threshold speed.

20. A storage medium in which is stored a program that causes a computer to execute the steps of the vehicle control method according to claim 19.
